(19) United States
(12) Patent Application Publication
(10) Pub. No.: US 2004/0247103 A1
(43) Pub. Date: Dec. 9, 2004

(54) Communication management device and communication device

(75) Inventor: Yoshifumi Tanimoto, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MURATA KIKAI KABUSHIKI KAISHA, Kyoto-shi (JP)

(21) Appl. No.: 10/857,893

(22) Filed: Jun. 2, 2004

(30) Foreign Application Priority Data
Jun. 4, 2003 (JP) 2003-160125
Jun. 4, 2003 (JP) 2003-160126

(51) Int. Cl. H04M 3/42; H04M 11/00; H04M 7/00

(52) U.S. Cl. 379/201.01; 379/88.12; 379/220.01

(57) ABSTRACT

A communication management device holds a management table that manages users of a first communication device through a sixth communication device connected to a network and status of the users, whether the users are absent or present. When a user A of the first communication device carries out a telephone conversation with a user K of the fourth communication device, the first communication device transmits information of the user K to the communication management device. The communication management device determines whether or not the user K is present in accordance with the management table. When the user K is present, the communication is established between the first communication device and the fourth communication device. Accordingly, unnecessary voice data can be prevented from being transmitted to the network.

### BACKGROUND OF THE INVENTION

1. Field of the Invention

The present invention relates to communication technology, and more particularly to technology for communicating by handling voice as digital data.

2. Description of the Related Art

Accompanying a development in network technology, devices, which are connected to a network such as a Local Area Network (LAN) and a Wide Area Network (WAN) and are capable of communicating with one another, are becoming widespread. Content handled by the devices includes not only text but also information which generally has a large data size such as an image or a voice. For example, based on various factors such as a development in a compression technique, a development in a network infrastructure and an improvement in a processing ability of a computer, it became possible for the image and the voice or the like to be communicated as the digital data. As a background of such a technology, for example, there is a Voice over Internet Protocol (VOIP). The VOIP implements a function that is the same as a telephone device which uses a Public Switched Telephone Network (PSTN) by using a network such as the Internet. There is technology for efficiently using a communication device that uses the VOIP (hereinafter referred to as the “IP telephone device”) and a conventional telephone device.

The IP telephone device can be used by adding the IP telephone device to a network in which a device such as a computer is connected. Since the IP telephone device transmits and receives voice data, traffic on the network increases rapidly when a telephone conversation is carried out by using the IP telephone device. In general, when carrying out a telephone conversation by using a telephone, first, a telephone number is dialed. Then, after a call is established, a conversation is started with a person who is different from an object person of the telephone conversation. For example, a conversation is carried out for asking the object person of the telephone conversation to be put on the telephone. A duration of the telephone call becomes long due to such a conversation and causes the network to be stressed. The IP telephone device can transmit and receive various pieces of information before establishing a call. Bu using this feature, the IP telephone device can present a service that cannot be presented by the conventional telephone device.

### SUMMARY OF THE INVENTION

The present invention has been made in view of such circumstances. An advantage of the present invention is to provide technology for efficiently carrying out communication between communication devices when a communication device that transmits and receives voice data is added to a network.

According to an aspect of the present invention, a device manages communication between a called device and a calling device. The device includes a storage unit and a status management unit. The storage unit stores user information that specifies a user of the called device and status information that designates whether the user can use the called device, by associating the user information and the status information with identification information that specifies the called device. The status management unit accepts information relating to an object person of a telephone conversation from the calling device. In accordance with the information relating to the object person of the telephone conversation and the user information, the status management unit references the status information of the object person of the telephone conversation stored in the store unit to determine whether or not the object person of the telephone conversation can use the called device. Then, the status management unit transmits a determination result to the calling device.

According to another aspect of the present invention, a device manages communication between a called device and a calling device. The device includes a storage unit, a selecting unit and an establishing unit. The storage unit stores by associating with identification information that specifies the called device, user information that specifies a user of the called device. The selecting unit accepts information relating to an object person of a telephone conversation from the calling device. The selecting unit references the storage unit to specify the identification information of the called device to be used by the object person of the telephone conversation. Then, the selecting unit determines whether or not the called device specified by the identification information is communicating with another device that is different from the calling device. When the communication is not carried out, the establishing unit establishes communication between the calling device and the called device.

The status management unit of the device can accept from the called device, user information of a user using the called device, and store the accepted user information in the storage unit.

The storage unit can store user information of each of a plurality of users using the called device by associating the user information with the identification information. When establishing communication, the establishing unit can call the called device and notify the user information of the user to be called.

According to another different aspect of the present invention, a device manages communication between a called device and a calling device. The device includes a storage unit, a selecting unit and an establishing unit. The storage unit stores by associating with identification information that specifies the called device, attribute information indicating a function of the called device. The selecting unit accepts information for specifying the called device from the calling device. The selecting unit references the storage unit to determine whether or not the accepted attribute information of the called device corresponds with attribute information of the calling device. When the attribute information correspond with one another, the establishing unit establishes communication between the calling device and the called device.

According to an aspect of the present invention, a communication device carries out communication with a destination device of the communication via a network. The communication device includes an accepting unit, a determining unit and a calling unit. The accepting unit accepts a designation of an object person of a telephone conversation from a user of the communication device. The determining unit determines whether or not the object person of the telephone conversation can use the destination device, without calling the destination device. The calling unit calls the destination device when the object person of the telephone conversation can use the destination device. Accordingly, only when the object person of the telephone conversation can have a telephone conversation, the communication device can call the destination device.

The communication device can further include a receiving unit and a holding unit. The receiving unit receives via a network, user information that specifies a user of the destination device and status information that designates whether or not the user can use the destination device. The holding unit holds the received user information and the status information by associating with information that specifies the destination device. The determining unit can carry out a determination by referencing the status information of the object person of the telephone conversation held by the holding unit.

The communication device can further include an output unit which accepts from a user of the communication device, user information that specifies the user, and outputs the user information to the network.

The communication device can further include a receiving unit and a notification unit. The receiving unit receives via the network, information for originating a call to the communication device and information relating to the user to be called. The notification unit notifies the user to be called.

The communication device further includes a transmitting unit. The transmitting unit transmits information that specifies the object person of the telephone conversation to a management device on a network. The management device holds by associating with information that specifies the destination device, the user information that specifies the user of the destination device and the status information that designates whether or not the user can use the destination device. The determining unit can acquire from the management device, information that designates whether or not the object person of the telephone conversation can use the destination device. Then, in accordance with the acquired information, the determining unit can carry out a determination.

The determining unit of the communication device can determine that the destination device can be used when a function of the communication device and a function of the destination device correspond with one another.

Further, any conversion of the combination of the above constituent elements or the expression of the present invention between a method, a device, a system, a recording medium, a computer program or the like is also effective as an embodiment of the present invention.

According to the present invention, by registering a user with a communication device such as the IP telephone device, a determination can be made as to whether or not communication can be carried out in accordance with a status of the user. Accordingly, unnecessary voice data can be prevented from being transmitted to the network. In addition, a convenient communication system can be provided.

### BRIEF DESCRIPTION OF THE DRAWINGS

FIG. 1 is a block diagram of a communication system according to a first embodiment of the present invention.

FIG. 2A is an external view of a communication device. FIG. 2B shows an example of a second display screen that displays a telephone directory. FIG. 2C shows an example of a third display screen displayed when there is an incoming call. FIG. 2D shows an example of a fourth display screen for carrying out a user registration.

FIG. 3 is a block diagram showing an inner configuration of a communication management device of FIG. 1.

FIG. 4 is a block diagram showing an inner configuration of a first communication device of FIG. 1.

FIG. 5 is a block diagram of a communication system according to a second embodiment of the present invention.

FIG. 6 is a block diagram showing an inner configuration of a first communication device of FIG. 5.

### DETAILED DESCRIPTION OF THE PREFERRED EMBODIMENTS

### First Embodiment

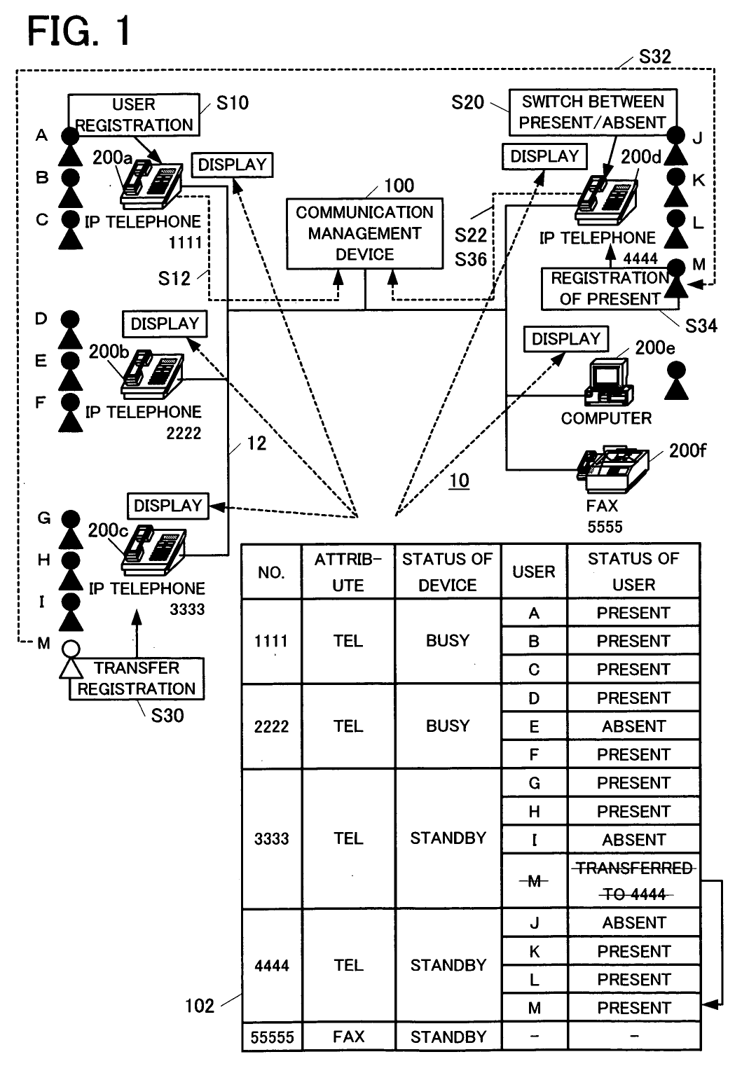

FIG. 1 is a block diagram of a communication system 10 according to a first embodiment of the present invention.

A first communication device 200a, a second communication device 200b, a third communication device 200c and a fourth communication device 200d (hereinafter referred to as the “communication devices 200”) are communication devices that use the VOIP. The communication devices 200 include a function for transmitting and receiving voice information via a network 12, respectively.

The first communication device 200a through the fourth communication device 200d are so-called Internet Protocol (IP) telephone sets that are exclusive for communication using the VOIP technology. A fifth communication device 200e is a personal computer or the like, and executes the VOIP function by executing a prescribed program. A sixth communication device 200f is a facsimile machine that transmits and receives image data by using the VOIP technology. Although details will be described later, the communication devices 200 include a function for registering a user for each device and notifying a communication management device 100 with the registration.

The communication management device 100 collectively manages information relating to a user of each of the communication devices 200 by a management table 102. The communication management device 100 specifies from user information of a calling destination (other party of a telephone conversation), a communication device 200 that is to be an actual calling destination. Then, the communication management device 100 establishes the communication. That is, a user operating a communication device 200 of a calling side can input a user of a desired destination of the telephone conversation, instead of inputting an extension number. Of course, the user of the communication device 200 can input an extension number and originate a call. Although details will be described later, the inputting operation of the calling destination can be carried out by using a telephone directory displayed on a touch screen or the like. As described above, by registering a user with the communication device 200, the user of the calling side is not required to be conscious of the extension number of the communication device 200 of the called side. For example, even when a user is transferred to a new communication device 200, by registering the user with the new communication device 200, a call can be originated to the new communication device 200.

The management table 102 stores for each of the communication devices 200, identification information, attribute information, information indicating status of the communication device 200 (hereinafter referred to as the “device status information”), user information and information indicating status of each user (hereinafter referred to as the “user status information”).

The identification information is information for identifying the communication device 200 on the network 12, such as a telephone number and an extension number. In FIG. 1, an extension number is shown as the identification information. For example, when carrying out communication in accordance with a Transmission Control Protocol/Internet Protocol (TCP/IP), an IP address is associated with the extension number, and the communication device 200 designates an IP address of the communication device 200 of a transmitting destination to a packet of voice data and transmits the packet. In short, the identification information can be information that identifies the communication device 200. The identification information includes information such as the telephone number to be used by a user for identifying the communication device 200. The identification information also includes identification information based on a communication protocol to be used, such as an IP address in the TCP/IP.

The attribute information is information that shows a function of the communication device 200 straightforward, such as a telephone, a facsimile or a data terminal. When an attribute of the communication device 200 of the called side and an attribute of the communication device 200 of the calling side correspond with one another, the communication management device 100 establishes communication between the communication devices 200. Accordingly, for example, the first communication device 200a, which is the IP telephone, can be prevented from being connected with the sixth communication device 200f, which is the facsimile machine. As a result, misdialing of the user can be prevented in advance. Consequently, an unnecessary communication packet can be prevented from overflowing to the network 12 and an increase in the traffic can be suppressed.

The device status information is information that shows a status of the communication device 200, such as busy (during communication), standby and failure. The communication management device 100 determines whether or not a connection can be established in accordance with the status of the communication device 200 of the called side. In case a connection can be established, the communication is established between the communication device 200 of the called side and the communication device 200 of the calling side. Accordingly, an unnecessary call can be prevented from being originated and an increase of the traffic in the network 12 can be suppressed.

The user information is various pieces of information relating to a user, such as a user ID (identification) and a user name. The user status information is information that shows a status of the user by modes such as present, absent and transferring. A plurality of users can be registered with the communication device 200. As described above, since the status can be managed for each user, for example, when the user is absent, a processing can be executed to not originate a call. Accordingly, an unnecessary communication packet can be prevented from generating and an increase of the traffic in the network 12 can be suppressed. Consequently, a range of the network 12 can be used effectively.

A process for registering a user with the communication device 200 will be described with a user A as an example. The user A registers user information with the first communication device 200a (step S10). In the present embodiment, the first communication device 200a accepts “A” as the user information and transmits the user information to the communication management device 100 (step S12). Then, the communication management device 100 associates “1111”, which is the identification information of the first communication device 200a, with the user information “A”, and rewrites the user status information into “present”. Accordingly, the first communication device 200a and the user A are associated with one another. The registration process can be carried out when the user uses the communication device 200 or can be carried out periodically.

A process for registering a status of a user with the communication device 200 will be described with a case in which a user J leaves from seat as an example. The user J instructs the fourth communication device 200d to change the user status information (step S20). The fourth communication device 200d transmits the user information “J” and information indicating “absent” to the communication management device 100 (step S22). Then, the communication management device 100 changes the user status information of the user “J” into “absent” in the management table 102. Accordingly, the status of the user can be switched. When the user returns to the seat, the user instructs to change the user status information into “present”.

A process for registering a transfer of a user with the communication device 200 will be described with a case in which a user M transfers to another seat as an example. The user M instructs the third communication device 200c to change the user status information into “transfer” (step S30), and transfers the seat to a proximity of the fourth communication device 200d (step S32). Then, the user M registers “present” with the fourth communication device 200d (step S34). That is, the user M registers the user information with the fourth communication device 200d. The fourth communication device 200d transmits the user information “M” to the communication management device 100 (step S36). Then, the communication management device 100 deletes the user information “M” from “3333”, which is the identification information of the third communication device 200c. Alternatively, the communication management device 100 rewrites the user information into information indicating that the user M is being transferred. Then, the communication management device 100 associates “4444”, which is the identification information of the fourth communication device 200d, with the user information “M”. In addition, the communication management device 100 rewrites the user status information into “present”. Accordingly, the fourth communication device 200d and the user M are associated. Moreover, when a prescribed period of time elapses after the user status information of the user is changed into “transfer”, the communication management device 100 can change the user status information into “absent”.

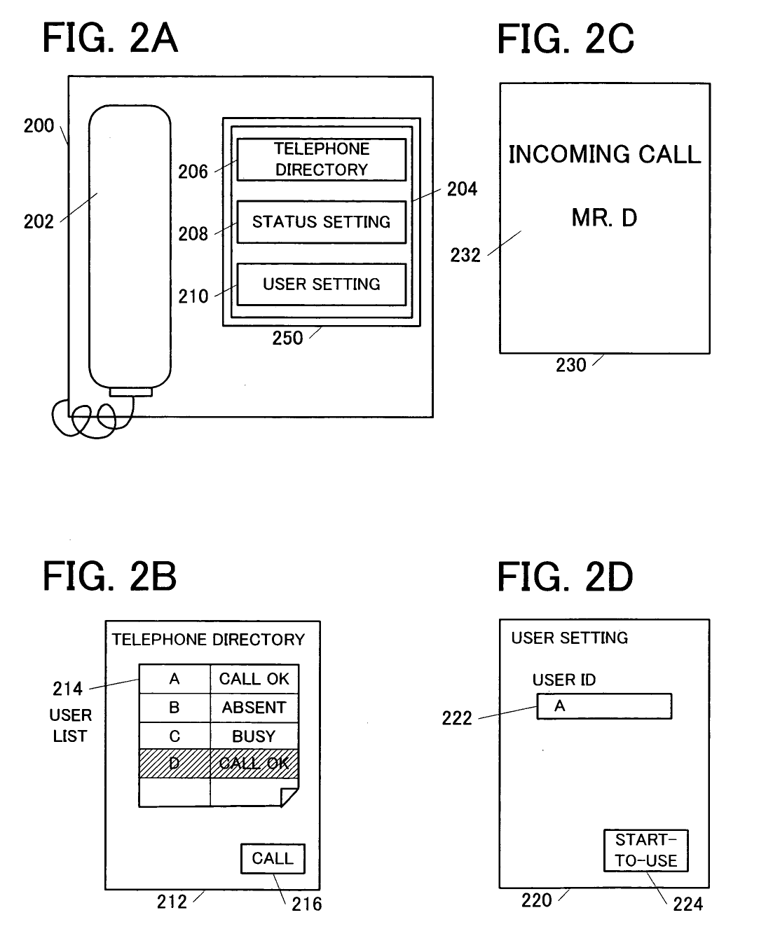

FIG. 2A is an external view of the communication device 200. The communication device 200 mainly includes a receiver 202 and a display unit 250. The display unit 250 is a touch screen or the like, and displays various screens and accepts an operation instruction from the user. A first display screen 204 is an example of a menu screen displayed while the communication device 200 is on standby. A first button 206 is a button for displaying a telephone directory. A second button 208 is a button for displaying an operation screen to set a status of the user. A third button 210 is a button for displaying an operation screen to register a user.

FIG. 2B shows an example of a second display screen 212 that displays the telephone directory. The second display screen 212 is displayed on the display unit 250 when the first button 206 is pressed. A user list 214 is a list of users that can be called. The user list 214 displays the users and the status. By touching the user to be called, the user of the calling destination is selected. In FIG. 2B, a user “D” is selected as the calling destination. A fourth button 216 is a button for instructing to originate a call to the selected user. By touching the fourth button 216, information of the user “D” is transmitted from the communication device 200 to the communication management device 100. Then, the communication management device 100 specifies the communication device 200 which has the registration of the user “D”. When the user “D” can carry out a telephone conversation, a call is originated to the user “D”.

FIG. 2C shows an example of a third display screen 230 displayed when there is an incoming call. The third display screen 230 is displayed while there is an incoming call. The third display screen 230 displays information 232 relating to the user being called. Accordingly, a user sitting in the vicinity of the communication device 200 can judge to whom the call is addressed. Of course, when there is an incoming call, the incoming call can be notified by a bell or a voice, not only by displaying such a fact.

FIG. 2D shows an example of a fourth display screen 220 for carrying out a user registration. The fourth display screen 220 is displayed on the display unit 250 when the third button 210 is pressed. A user ID input field 222 is a field for inputting a user ID or the like. The input can be made from a soft keyboard displayed on the display unit 250 or can be carried out by existing technology such as a voice recognition. By operating a start-to-use button 224, the user ID input in the user ID input field 222 is determined “present” and registered with the management table 102. The fourth display screen 220 also includes a button (not shown) that registered the input user ID as “absent” or “transferring”.

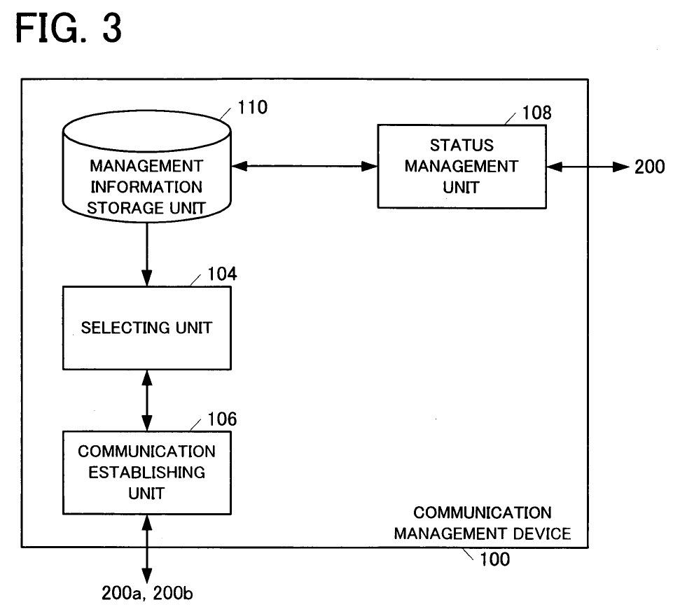

FIG. 3 is a block diagram showing an inner configuration of the communication management device 100 of FIG. 1. In terms of hardware components, each of the constituent elements of the communication management device 100 is implemented mainly by a Central Processing Unit (CPU) of a computer, a memory, a program loaded in the memory for implementing the constituent elements of FIG. 3, a storage unit such as a hard disk for storing the program, and an interface for establishing a network connection. It is to be understood by those skilled in the art that there are variations to methods and devices for implementing each of the constituent elements. Each of the drawings to be described hereinafter shows blocks representing units of function, instead of units of hardware.

A status management unit 108 accepts various pieces of information such as the user information, the user status information and the device status information (hereinafter referred to as the “status information”) from the communication device 200. Then, the status management unit 108 stores the status information into a management information storage unit 110. The management information storage unit 110 stores the management table 102 described in FIG. 1. Although details will be described later, for example, when a user registration is carried out, in case the status of the user changes to “present”, “absent” or “transferring”, the communication device 200 transmits the status information.

The status management unit 108 receives the status information from the communication device 200, and updates a content of the management information storage unit 110 as occasion arises. Therefore, the management information storage unit 110 always stores the newest information relating to each of the communication devices 200. Further, in the present embodiment, at a point of time when the user that is transferring carries out a user registration with the communication device 200 of the transferred destination, the management table 102 of FIG. 1 stored in the management information storage unit 110 is updated. As another example, instead of providing a mode of “transferring”, at a point of time when the user that is transferring simply carries out a user registration with the communication device 200 of the transferred destination, the management table 102 can be updated.

The status management unit 108 reads the user information from the management information storage unit 110, and transmits a list of the user information such as a telephone directory to the communication device 200. When the communication device 200 requests the user list, the status management unit 108 can transmit the user list. Alternatively, at a point of time when there is a change in any of the communication devices 200, the status management unit 108 can transmit the user list. The status management unit 108 can transmit the entire user list each time, or can transmit only differential information.

A communication establishing unit 106 establishes communication between the communication device 200 of the calling side and the communication device 200 of the called side. In the following, the communication device 200 of the calling side will be referred as the first communication device 200a of FIG. 1 and the communication device 200 of the called side will be referred as the second communication device 200b, and the embodiment will be described.

First, the communication establishing unit 106 accepts a user ID of a user to be called from the first communication device 200a, and outputs the accepted user ID to a selecting unit 104. Then, the communication establishing unit 106 accepts information necessary for establishing a connection from the selecting unit 104, and establishes the communication between the first communication device 200a and the second communication device 200b. When receiving from the selecting unit 104, information indicating that the user to be called is “absent” or “transferring” or information indicating a status of the communication device 200 of the called side being busy or failure, the communication establishing unit 106 transmits such a fact to the communication device 200 of the calling side to notify that the communication cannot be established.

For example, when receiving an IP address of the second communication device 200b from the selecting unit 104, the communication establishing unit 106 transmits towards the received IP address, information indicating a call, information of a user to be called, and an IP address of the first communication device 200a that originated the call. Then, when the second communication device 200b receives the call, the second communication device 200b transmits information indicating that a call has been received to the IP address of the first communication device 200a. Accordingly, the communication is established between the first communication device 200a and the second communication device 200b. By adding the information of the user to be called to the second communication device 200b, the second communication device 200b can display the incoming call screen described with reference to FIG. 2C.

As another example, the communication establishing unit 106 can transmit to the first communication device 200a, the IP address of the second communication device 200b received from the selecting unit 104. The first communication device 200a can transmit to the IP address of the second communication device 200b, information indicating that a call has been originated and information of the user to be called. Accordingly, the communication establishing unit 106 can establish the communication between the first communication device 200a and the second communication device 200b. There are various methods for establishing the communication between the communication device 200 of the calling side and the communication device 200 of the called side. The communication establishing unit 106 can include at least a function for accepting the information of the user to be called and returning the information necessary for establishing a connection with the communication device 200 in which the user is registered. Other processes in the communication establishing unit 106 are carried out appropriately according to an establishing method.

The selecting unit 104 searches the management table 102 of FIG. 1 stored in the management information storage unit 110 with the user information as a key. The selecting unit 104 specifies the status of the designated user, the registered communication device 200, and the attribute information of the communication device 200. When the attribute information matches and the status of the user is “present”, the selecting unit 104 supplies to the communication establishing unit 106, identification information such as the IP address for establishing a connection with the registered communication device 200. When the status of the user is “absent”, the selecting unit 104 supplies to the communication establishing unit 106, information indicating that the user is absent. When the status of the user is “transferring”, the selecting unit 104 supplies to the communication establishing unit 106, information indicating that the user is transferring. When the status of the device is “busy” or “failure” and communication cannot be established newly, the selecting unit 104 outputs such a fact to the communication establishing unit 106.

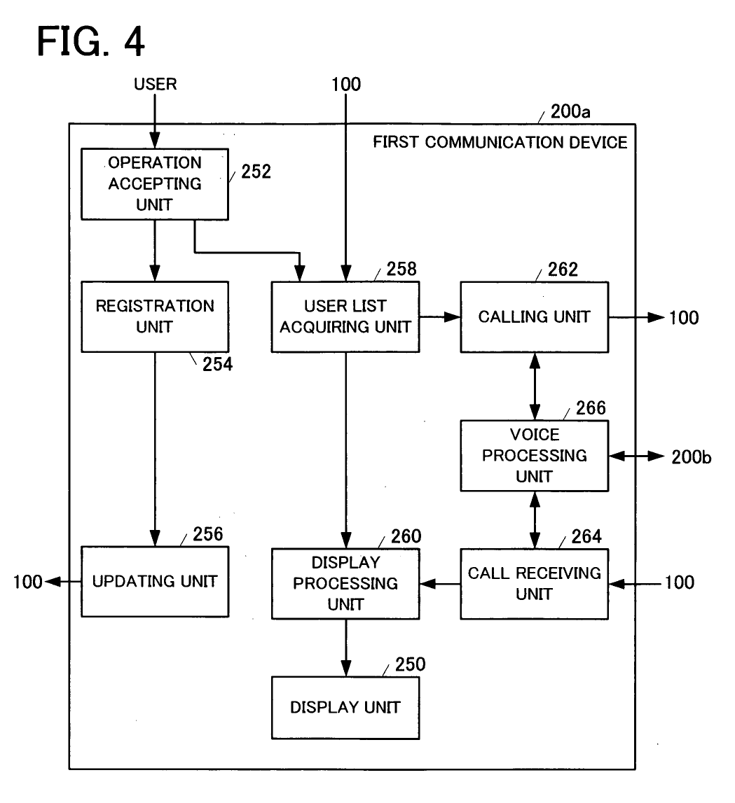

FIG. 4 is a block diagram showing an inner configuration of the first communication device 200a of FIG. 1. A basic inner configuration of the second communication device 200b, the third communication device 200c, the fourth communication device 200d, the fifth communication device 200e and the sixth communication device 200f of FIG. 1 is approximately the same as the first communication device 200a. An operation accepting unit 252 presents a user interface for accepting various operation instructions from the user.

The operation accepting unit 252 displays each of the display screens of FIG. 2A through FIG. 2D on the display unit 250. In addition, the operation accepting unit 252 accepts an operation of a user via various input devices such as a touch screen, a touch panel, a button and a mouse. The operation accepting unit 252 can include a fingerprint recognition device for carrying out a user registration. By providing the fingerprint recognition device, it becomes unnecessary for the user to input the user ID.

A registration unit 354 accepts various pieces of information from the operation accepting unit 252 and outputs an instruction to an updating unit 256 and a user list acquiring unit 258. When accepting information relating to the user registration, the registration unit 254 instructs the updating unit 256 to transmit information indicating the user registration.

In accordance with the instruction, the updating unit 256 associates information that identifies the first communication device 200a, such as an extension number and an IP address, with the user ID of the user to be registered. Then, the updating unit 256 transmits the associated information and the user ID as the status information to the communication management device 100. When accepting information relating to a change in the status of the user, or when there is a change in the status of the device, for example, when the first communication device 200a is busy or there is a failure in the first communication device 200a, the registration unit 254 instructs the updating unit 256 to transmit information indicating such a fact as the status information. Then, the updating unit 256 transmits the status information to the communication management device 100. When there is a change in the information for registering with the management table 102 of the communication management device 100, the registration unit 254 can instruct the updating unit 256 to transmit the information.

The user list acquiring unit 258 acquires the user list from the communication management device 100.

A display processing unit 260 displays the telephone directory described with reference to FIG. 2B on the display unit 250 in accordance with the user list. When the operation accepting unit 252 is instructed to display the telephone directory from the user, the operation accepting unit 252 notifies such a fact to the user list acquiring unit 258. Then, when receiving the notification, the user list acquiring unit 258 can acquire the user list from the communication management device 100. When a prescribed event is carried out, for example, when the user touches the receiver 202 of FIG. 2A, when receiving a notification of a change in the user list from the communication management device 100, or when a user registration is carried out, the user list acquiring unit 258 can acquire the user list. For detecting such an event, the user list acquiring unit 258 can include a function for detecting such an event.

A calling unit 262 transmits to the communication management device 100, the user information of the user of the calling destination (other party of the communication), and requests the communication management device 100 to originate a call to the communication device 200 of the calling destination. Then, when the communication is established between the first communication device 200a and the second communication device 200b, a voice processing unit 266 transmits and receives voice data to enable a telephone conversation between the users. A call receiving unit 264 accepts from the communication management device 100, information indicating that a call has been originated and information of the user to be called. Then, the call receiving unit 264 notifies the incoming call by a bell or a voice. The call receiving unit 264 instructs the display processing unit 260 to display a screen indicating that there is an incoming call, described with reference to FIG. 2C.

### Second Embodiment

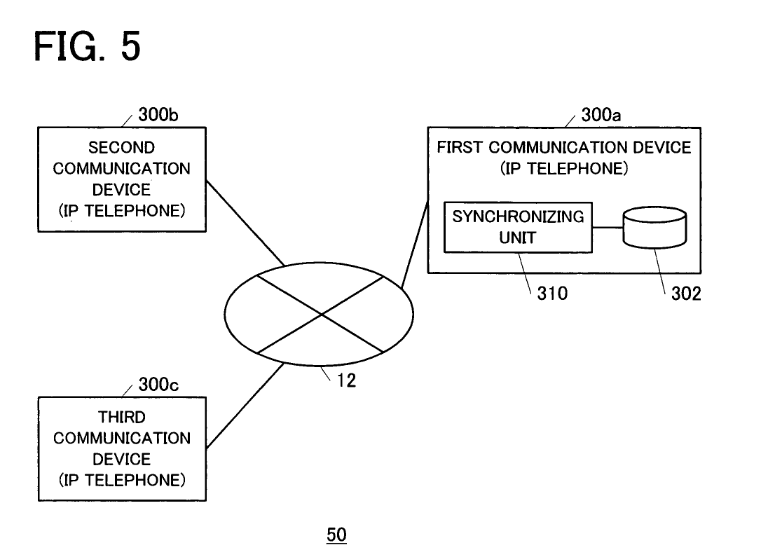

FIG. 5 is a block diagram of a communication system 50 according to a second embodiment of the present invention.

According to the second embodiment, the management table 102 of FIG. 1 is dispersed and managed. A first communication device 300a, a second communication device 300b and a third communication device 300c (hereinafter referred to as the “communication devices 300” in some cases) have the same structure and are connected to the network 12, respectively. Each of the communication devices 300 is an IP telephone device, and transmits and receives voice data via the network 12. Each of the communication devices 300 includes a management information storage unit 302 that stores the management table 102 of FIG. 1 and a synchronizing unit 310 for synchronizing the contents of the management table 102 of each of the communication devices 300. Although details will be described later, when a user registration is carried out in the communication device 300, when a status of the user is changed, or when a status of the device is changed, the synchronizing unit 310 broadcasts the status information indicating such a fact to the network 12. Another communication device 300 receives the broadcasted status information and updates the content of the management table 102. Accordingly, each of the communication devices 300 can use the stored management table 102 to specify the identification information of the communication device 300 of the calling destination. When the user to be called can carry out a telephone conversation, the communication device 300 can generate a call.

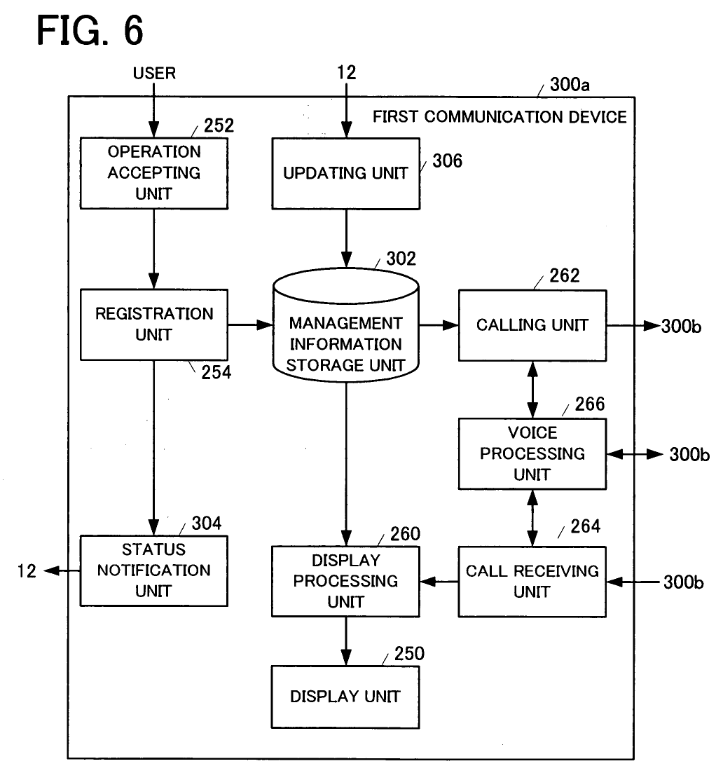

FIG. 6 is a block diagram showing an inner configuration of the first communication device 300a of FIG. 5. The structures in FIG. 6 having the same reference numeral as the already described structures have approximately the same function and operation as the already described structure. In the following, a description will be made mainly to parts that are different from functions of the already described structures.

The registration unit 254 stores status information in a management information storage unit 302. Further, the status information to be stored into the management information storage unit 302 is information indicating a user registration, a change in the status of the user and the status of the device, or the like. The registration unit 254 instructs a status notification unit 304 to notify the status information. The status notification unit 304 broadcasts the status information to the network 12.

An updating unit 306 receives the status information broadcasted from another communication device 300. Then, in accordance with the status information, the updating unit 306 updates the content of the management table 102 stored in the management information storage unit 302. The management tables 102 are synchronized by the status notification unit 304 and the updating unit 306. The synchronizing unit 310 of FIG. 5 corresponds to the status notification unit 304 and the updating unit 306. The calling unit 262 includes a function that is the same as the selecting unit 104 of FIG. 3. The calling unit 262 references the management information storage unit 302 with the information of the user of the calling destination as a key, and specifies the identification information of the communication device 300 of the calling destination. Then, the calling unit 262 originates a call to the communication device 300 of the calling destination. When the user to be called can carry out a telephone conversation, the communication is established.

The present invention has been described in terms of embodiments. It is to be understood by those skilled in the art that the embodiments are examples and that there are variations to combinations of the constituent elements and processing processes and those variations also fall within the scope of the present invention.

What is claimed is:

1. A communication management device comprising:
a storage unit that stores by associating with identification information which specifies a called device, user information which specifies a user of the called device and status information which indicates whether the user can use the called device; and
a status management unit that accepts information relating to an object person of a telephone conversation from a calling device, and in accordance with the information relating to the object person of the telephone conversation and the user information, references the status information of the object person of the telephone conversation stored in the storage unit to determine whether the object person of the telephone conversation can use the called device, and transmits a determination result to the calling device.

2. The communication management device according to claim 1, wherein the status management unit accepts from a called device, user information of a user who uses the called device, and stores the user information in the storage unit.

3. A communication management device comprising:
a storage unit that stores by associating with identification information which specifies a called device, user information which specifies a user of the called device;
a selecting unit that accepts information relating to an object person of a telephone conversation from a calling device and references the storage unit to specify identification information of the called device to be used by the object person of the telephone conversation, and determines whether the called device specified by the identification information is carrying out communication with another device that is different from the calling device; and
an establishing unit that establishes communication between the calling device and the called device when the communication with the another device that is different from the calling device is not carried out.

4. The communication management device according to claim 3, further comprising a status management unit that accepts from the called device, the user information of the user using the called device, and stores the user information into the storage unit.

5. The communication management device according to claim 3, wherein the storage unit stores user information of each of a plurality of users using the called device by associating the user information with the identification information, and when establishing the communication, the establishing unit originates a call to the called device and notifies the user information of the user to be called.

6. The communication management device according to claim 4, wherein the storage unit stores user information of each of a plurality of users using the called device by associating the user information with the identification information, and when establishing the communication, the establishing unit originates a call to the called device and notifies the user information of the user to be called.

7. A communication management device comprising:
a storage unit that stores by associating with identification information which specifies a called device, attribute information which indicates a function of the called device;
a selecting unit that accepts information for specifying the called device from a calling device and references the storage unit to determine whether the accepted attribute information of the called device corresponds with attribute information of the calling device; and
an establishing unit that establishes communication between the calling device and the called device when the attribute information correspond.

8. A communication device, which carries out communication with a destination device of the communication via a network, comprising:
an accepting unit that accepts a designation of an object person of a telephone conversation from a user of the communication device;
a determining unit that determines whether the object person of the telephone conversation can use the destination device; and
a calling unit that originates a call to the destination device when the object person of the telephone conversation can use the destination device.

9. The communication device according to claim 8, further comprising:
a receiving unit that receives via the network, user information which specifies a user of the destination device and status information which designates whether the user can use the destination device; and
a holding unit that holds the received user information and the status information by associating with information which specifies the destination device;
wherein the determining unit carries out the determination by referencing the status information of the object person of the telephone conversation held in the holding unit.

10. The communication device according to claim 8, further comprising an output unit that accepts from a user of the communication device, user information which specifies the user, and outputs the user information to the network.

11. The communication device according to claim 9, further comprising an output unit that accepts from a user of the communication device, user information which specifies the user, and outputs the user information to the network.

12. The communication device according to claim 8, further comprising:
a receiving unit that receives via the network, information for originating a call to the communication device and information relating to a user to be called; and
a notification unit that notifies the user to be called.

13. The communication device according to claim 9, further comprising:
a receiving unit that receives via the network, information for originating a call to the communication device and information relating to a user to be called; and
a notification unit that notifies the user to be called.

14. The communication device according to claim 10, further comprising:
a receiving unit that receives via the network, information for originating a call to the communication device and information relating to a user to be called; and
a notification unit that notifies the user to be called.

15. The communication device according to claim 8, further comprising:
a transmitting unit that transmits information which specifies the object person of the telephone conversation to a management device on the network which holds by associating with information which specifies the destination device, user information which specifies the user of the destination device and status information which designates whether the user can use the destination device;
wherein the determining unit acquires from the management device, information which designates whether the object person of the telephone conversation can use the destination device, and carries out a determination in accordance with the acquired information.

16. The communication device according to claim 8, wherein when a function of the communication device and a function of the destination device correspond, the determining unit determines that the destination device can be used.

17. The communication device according to claim 9, wherein when a function of the communication device and a function of the destination device correspond, the determining unit determines that the destination device can be used.

18. The communication device according to claim 10, wherein when a function of the communication device and a function of the destination device correspond, the determining unit determines that the destination device can be used.

19. The communication device according to claim 12, wherein when a function of the communication device and a function of the destination device correspond, the determining unit determines that the destination device can be used.

20. The communication device according to claim 15, wherein when a function of the communication device and a function of the destination device correspond, the determining unit determines that the destination device can be used.
